(19) United States
(12) Patent Application Publication
(10) Pub. No.: US 2004/0153664 A1
(43) Pub. Date: Aug. 5, 2004

(54) Method, a locator agent unit, a distributed locator system and a computer software product for coordinating location dependent information, services, and tasks

(75) Inventors: Horst Rossler, Filderstadt (DE); Michael Walter Hoche, Schwieber-dingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/733,567

(22) Filed: Dec. 12, 2003

(30) Foreign Application Priority Data
Jan. 31, 2003 (EP) 03360012.3

(51) Int. Cl. G06F 12/14

(52) U.S. Cl. 713/200

(57) ABSTRACT

The invention relates to a method for coordinating location dependent information, services, and tasks, comprising the steps of deriving and refining location information of a user based on location measurements or proximity observations (MD), providing actual location information and/or planned location information of a user, initiating tasks and providing information and services dependent on tracking information and planned location information wherein the location information is provided by a locator entity (Loc) in a distributed system gathering location measurements or proximity observations (MD) and aggregating said actual and/or said planed location information and wherein the locator entity (Loc) is restricting the accesses to said location information by authenticating, authorizing, and/or trusting inquirer parties (Clnt), and serving location information requests (RI) according to inquirer's grants and restrictions. It further relates to a locator agent unit (Loc), a locator device (Det), a locator client device (Clnt), a distributed locator system, and a computer software product.

### TECHNICAL FIELD

The present invention relates to telecommunication with location and proximity awareness. More particularly, the present invention relates to a method, a distributed locator system, a locator agent unit, a locator device, a locator client, and a computer software product.

The invention is based on a priority application, EP 03360012.3, which is hereby incorporated by reference.

### BACKGROUND OF THE INVENTION

A telecommunication with location and proximity awareness is known from e.g. the international patent application WO 98/54682, describing the generation and delivery of travel-related, location-sensitive information.

Mobility in the wireless world comes with a paradox. On the one hand, the mobile user is location-neutral and able to access services from any location. On the other, mobile networks are location-aware, by necessity, in order to route message to and from users who are moving around within the service area covered by the network.

Mobile devices liberated people to communicate on a person-to-person basis, instead of calling from one place to another place. The Internet today is still restricted by the same factor that communication used to be location dependent. We believe that people will welcome the possibility to access the services and information that they need at any given time or place and to access location-relevant content from a mobile device.

The value of information seems to be a function of three elements: personal relevance, location, and time. Information about the closest place to get local currency, for example, can be very important when you are traveling, but of no value to you when you are back at home. A method for combining time and place gives another dimension to the value of information.

Such a method is known from International Patent Application No. WO 02/1 7567 A2. There a system is disclosed enabling the dissemination of location information between user terminals and to and from network resources and the utilization of the location information in a manner convenient to users.

Similarly, US Patent Application Publication No. US 2001/0036224 A1 discloses a system and method for the delivery of targeted data over wireless networks. And US Patent Application Publication No. US 2002/0042278 A1 discloses an intelligent remote location system. A region modeling for location services could be found in US Patent Application Publication No. US 2002/0057283 A1. International Patent Application Publication No. WO 02/058426 A1 describes another system for facilitating the delivery of location information. And U.S. Pat. No. 6,049,819 provides a communication system incorporating an agent oriented computing environment.

High-speed information and communication services becoming available through network enhancements like General Packet Radio Services (GPRS) and third-generation Universal Mobile Telecommunications System (UMTS) should enable rapid development of a diverse range of advanced location-based services.

Along with the potential for location-aware services to add value comes a new kind of privacy concern. The network operator knows a subscriber's location, and operators must use this information to enable services according to the subscriber's wishes. An often-cited example of location-based services goes something like this: You are walking past a coffee shop and you get a coupon message on your mobile phone inviting you to come in and have a cup of coffee at a reduced price. This type of service may be attractive to some, but for others it might have overtones of “Big Brother's watching you!”

Control over location-based services must be firmly and unambiguously placed in the user's hands.

Dealing with all available information is using the context of an application to adopt the information presented. One context for mobile systems is location.

U.S. Pat. No. 6,327,535 describes a context aware computing system and method, where hierarchical structures are used implementing context information (location).

The term context awareness has been used in a wide range of concepts and applications for different types of information technology artifacts. For instance even help functions in our office applications claim to be context aware when they try to figure out what we are having problems with when turning to the help function. The navigation help in cars that knows where the car is located is also called context aware.

Obviously context can be used to describe a wide area of characteristics, ranging from defining the context as knowing what a user is doing, what other applications in the same computer are doing, or knowing where a user is located.

The context of an application or an artifact can be divided into physical environment, assumptions or models, and human factors. The human factors include the state of the user, what task he or she is performing as well as his or her condition. The physical environment is at a lower abstraction level and consists of physical variables, e.g. position or other physical conditions. The model assumptions reflects the fact how location information is interpreted. For instance in the context of a museum visitor might be rather stating relative location information than to present absolute terrestrial location information in Universal Transverse Mercator (UTM) coordinates. Using models is about setting a frame of reference.

There are two basic types of techniques to gain location awareness, namely relative or absolute positioning (with respect to a reference).

There are a number of different technologies for absolute positioning, e.g. the Global Positioning System (GPS) or Global System for Mobile communication (GSM) cell information together with the Mobile Positioning System (MPS).

Relative location aware systems are, in contrast to absolute location awareness, aware of what other objects that are in their proximity. The objects can be moved around and when using relative location awareness a system could recognize other objects without pending on where the device is located.

If a system uses absolute positioning and is able to communicate with a network it is possible to simulate relative location awareness. Relative positions can be sheaved into absolute as soon as one relative object is anchored within a context.

A locator service application focus spatial collaboration: A large part of life is collective, involving discussions and joint explorations. Life is very much about exploring how to frame the events taking place. In a sense, it is not about finding answers to questions, but rather to frame the problem and give the correct background. Activities are very time dependent. Many activities even cannot be done more than once. It is advantageous to facilitate contacts between collaborating parties that could contribute to each other's task when they are within a context close to each other, e.g. geographically, in a time frame, or a shared concern.

For this type of application it is advantageous to use agent technology. An (information) agent is an (computational software) entity that may access one or multiple, distributed, and heterogeneous information sources available, and pro-actively acquires, mediates, and maintains relevant information on behalf of its user(s) or other agents preferably just-in-time.

In other words, information agents are supposed to cope with the difficulties associated with the information overload of the user. This implies their ability to semantically broker information by providing a pro-active resource discovery; resolving the information impedance of information consumers and providers; offering value-added information services and products to the user or other agents.

Intelligent information agents may be classified according to one or more of the following features: Non-cooperative or cooperative information agents, depending on the ability if the agents cooperate with each other for the execution of their tasks. Adaptive information agents are able to adapt themselves to changes in networks and information environments. Rational information agents behave utilitarian in an economic sense. They are acting, and may even collaborate together, to increase their own benefits. Mobile information agents are able to travel autonomously through the Internet. Such agents enable, dynamic load balancing in large-scale networks, reduction of data transfer among information servers, and migration of small business logic within medium-range corporate intranets on demand.

Regarding the basic skills of information agents one differentiates between communication, knowledge, and collaboration.

Communication skills of an information agent include either communication with information systems and detectors, human users, or other agents. In the latter case, the use of a commonly agreed agent communication language (ACL) such as FIPA ACL and KQML has to be considered on top of, for example, middleware platforms or specific application interfaces.

Technologically an agent is a computer system that is situated in some environment, and that is capable of autonomous action in this environment in order to meet its design objectives.

To reach context awareness one first have to identify the context. In the case of location and proximity awareness the context is the position—either relatively or absolute—of a (telecommunication) device or an associated person.

The following devices have to be distinguished: a located device, a to be located device or user, and a locating device or detecting devices which is called locator device. These devices might coincide meaning they might be integrated.

A to be located device is the device that has to be classified by its position. The detector devices have to measure or observe this location information. There are two location information classes, absolute and relative ones. Correspondingly there are multiple types of detectors providing e.g. proximity measurements, direction measurements, position measurements etc.

Starting from ad hoc solutions transforming certain coordinates or positions into a series of activities on a trajectory are well known, e.g. from a navigation system optimizing a route with respect to tasks. Sensor data fusion, i.e. technologies to extract based on sensor images object information using pattern matching, tracking, etc. are also well known.

The problem to be solved by this invention is providing an improved uniform application interface for personal location information.

### SUMMARY OF THE INVENTION

This problem is solved by a method for coordinating location dependent information, services, or tasks, comprising the steps of

deriving and refining location information of at least one user based on location measurements or proximity observations,

providing location information of said at least one user,

initiating tasks, providing information, or services dependent on said location information,

by a locator entity in a distributed system gathering said location measurements or proximity observations and aggregating said location information of said of at least one user, said locator entity restricting the accesses to said location information by further comprising the steps of

authenticating and authorizing or trusting inquirer parties, and

serving location information requests according to inquirer's grants

wherein said grants depend on the relative location or absolute location of an inquirer or a user, an inquirer's identity, an inquirer's intention, a user's intention, time, or an information exchange contract.

The problem is further solved by a Locator Agent Unit for coordinating location dependent information, services, or tasks,

comprising locating means for receiving and/or deriving location information and providing location information and

comprising means for initiating tasks or services dependent on the derived location information

comprising a uniform networking interface for detecting devices feeding location information, enabling communication with inquirers' and other parties' client, and allowing controlling the locator agent unit, wherein said locator agent unit comprises

investigation means for identifying and coordinating location information sources or inquirers' and other parties' clients.

The problem is also solved by a Locator Device for coordinating location dependent information, services, and tasks, providing location measurements and proximity observations of a user, wherein said locator device provides a network interface to a locator agent unit's investigation means for identifying and coordinating location information sources or inquirers' and other parties' clients.

And the problem is solved by a Locator Client Device for exchanging location dependent information or coordinating location dependent services or tasks by comprising communication means for communicating requests and location dependent information wherein said locator client device comprises a network interface to a locator agent unit's investigation means for identifying and coordinating location information sources or inquirers' and other parties' clients.

Furthermore, the problem is solved by a Distributed Locator System for providing coordinated location information dependent information, services, or tasks, comprising a network and locator agent units providing a uniform location information interface, wherein a personalized locator agent unit is located in the distributed locator system dependent on said location information.

In other words the invention is a system which seeks (locates) people or people's devices and provides useful information for those who seek them. The system comprises means for providing limited and restricted location information of people who want to be found. The system is preferred being an agent providing and managing location information.

The invention might be realized by a personalized intelligent (software) agent having a uniform application interface providing location information. This agent is called in the following personalized locator agent unit.

This personalized locator agent unit might be a proactive agent supporting several kinds of contextual awareness, e.g. proximity awareness of other user's, location-task awareness, or location-time awareness.

A system able to find people at any time, anywhere is a powerful tool, preferably having control mechanisms and configuration possibilities according to users' demands and it should keep privacy, e.g. avoiding undesired people tracking you, no disturbance at specific locations or no disturbance during a specific period of date/time, e.g. business hours.

The personalized locator agent unit generates a synthesis of location information. Such a synthesis or aggregation might be a combination of multiple measurements in order to concentrate the occurrence probability. It records and analyzes the user's tracking path, e.g. GPS location data and time over a period of time.

A proactive agent preferably provides a user with the opportunity to attach access control configurations to individual locations (analyzed) depending on the identified persons preferences. Moreover the proactive agent might offer the attachment of arbitrary information, e.g. a uniform resource identificator with something about the location, which will be automatically offered to the person who found the user.

When a user reaches an individual location, the attached access configuration is automatically activated and might restrict other people to find this user.

The identification and authorization of an inquirer as well as the provided information might require certain cryptology techniques, e.g. public keys and electronic certificates or signatures.

The suggested solution provides means to gather, aggregate, and deploy (personal) location information in a networking environment. It enabled deploying location aware and location dependent services using a generic personalized and private application interface for personal location information and personal interaction management.

Accordingly, it is an object and advantage of the present invention realizing location aware devices and services in a simple way with an enhanced and simplified design and deployment of location awareness by delegation of functionality into location agent units.

Another advantage of the present invention is enabling private and secure interoperation of location aware services.

### BRIEF DESCRIPTION OF THE DRAWINGS

These and many other objects and advantages of the present invention will become apparent to those of ordinary skill in the art from a consideration of the drawings and ensuing description.

FIG. 1 is a schematic drawing of a location model used by a locator agent unit according to the invention.

FIG. 2 is a schematic drawing of a locator agent unit according to the invention.

FIG. 3 is a schematic drawing of a of a locator agent unit and its networking interfaces to locator devices and locator client devices according to the invention.

FIG. 4 is a schematic drawing of a scenario illustrating the functionality of a distributed locator system according to the invention.

FIG. 5 is a schematic drawing of distributed locator agent units within a distributed locator system according to the invention.

### DETAILED DESCRIPTION OF THE DRAWINGS

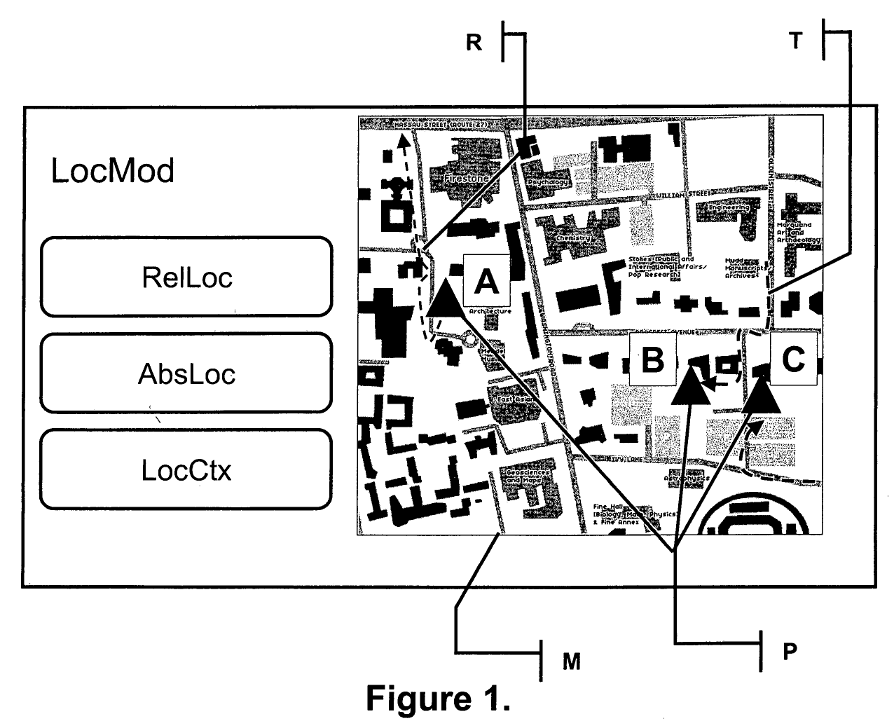

FIG. 1 shows a location model LocMod used by a locator agent unit according to the invention. The location model comprises of relative location information RelLoc, absolute location information AbsLoc with respect to a coordinate system or a map M, and a location context LogCtx, e.g. a running task like shopping or a location environment like a museum or a campus. Even time is considered as a location context.

The map might comprise of location context information like buildings or streets, or plans etc. The location model contains three entities, e.g. persons A, B and C. The positions P of the persons A, B and C are represented by black triangles. There are also dashed arrows for routes R and traces T. A trace is a list of already visited points and a route is a list of expected to be visited points. (Point means here time location combinations.) The arrows indicate the direction of movement.

There is an obvious distance between two objects (represented in a location model), e.g. the Euclidean metric.

Suppose for a moment that the map is oriented, i.e. north is upside and south is correspondingly downside. The location model shows that person A, located at the left hand side will move north. There is no route information for the other two persons, but trace information. Person B came from north while person C came from south.

The location model provides a way of concluding about location information, what location information is intended for, and how it is interpreted. It provides a context for interpretation.

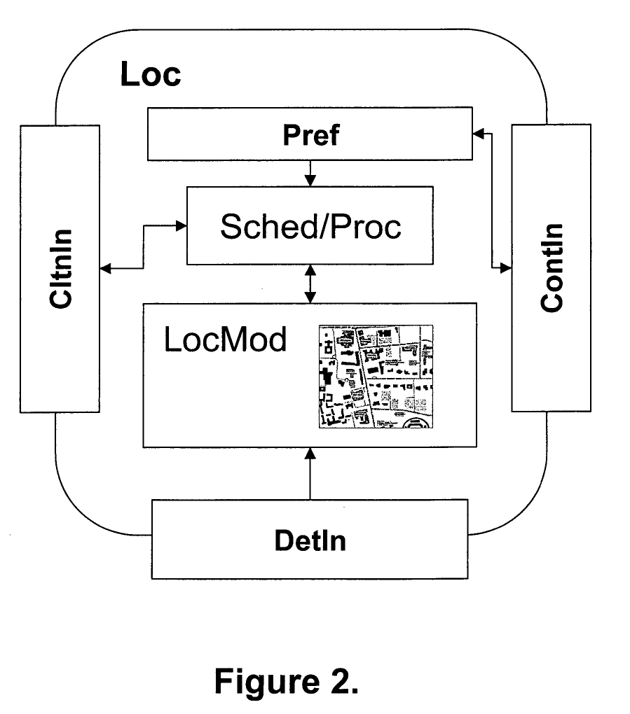

FIG. 2 shows a schematic drawing of a locator agent unit Loc. The locator agent unit comprises a location model LocMod, a processor unit with a scheduler Sched/Proc, user preferences Pref, and three uniform networking interfaces, a control interface Contln, a client interface Cltnin, and a detector interface Detln.

The networking interfaces Contln, Cltnln, and Detln enable the locator agent unit to interact with other components in a distributed system. The interfaces might be realized by an integrated common interface. It is here decomposed into three interfaces to illustrate interactions and functionality.

The control interface Contln enables a user to configure the locator agent unit's behavior, e.g. by defining preferences Pref. The detector interface Detln enables the locator agent unit to gather location measurements and/or observations about where the represented person (device) is located. The client interface Clntln enables locator clients and locator agent units to exchange requests, queries, and especially locator information.

The locator agent unit Loc comprises a realization of a location model LocMod carrying the information about location context and location of observed objects. Such object might present the user itself as well as other collaborating entities like persons, devices, or places, e.g. rooms or buildings. These objects might be placed in a space or a map spanned by a coordinate system.

To enable the locator agent unit to interact with the distributed locator system a processor unit Proc is coordinated by a scheduler Sched based on the location information retrieved out of the location model LocMod performing certain interactions with locator clients, e.g. like providing a proximity alert or providing certain tasks when the user is at certain times at certain locations. The processor unit Proc is the unit providing location information to privileged users, i.e. users with granted access. It might act proactive according to the defined preferences Pref. This is the unit responsible for verifying an inquirer's identity and authorization to request certain location information. For an authenticated inquirer's request with approved grants to get certain location information, according to the defined preferences Pref, the processor should serve the requests accordingly and optionally cryptographically secured to ensure real privacy.

The preferences Pref modifiable via the control interface Contln comprising location information access grants and restrictions. These grants might be based on contracts e.g. between other locator agent units or directives from the locator agent unit user. It might further comprise resolutions for unauthorized location information request and exception scenarios, e.g. when the location models LocMod between parties need to be aligned. The user's preferences might be time dependent as well as location dependent or in general context dependent. Preferences here is intended to mean behavioral description and might even comprise entries such as control commands, task lists, or contracting instructions.

The locator agent unit Loc provides a kind of locator service through the client interface Cltnln. This networking interface enables a locator client finding a person, i.e. retrieving certain location information or providing certain location information.

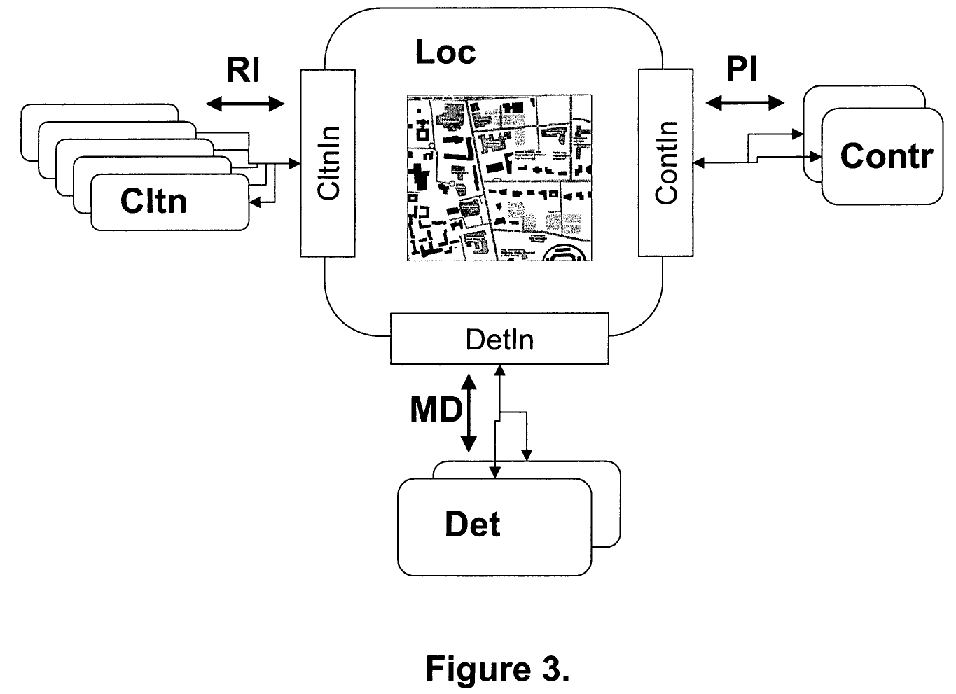

FIG. 3 shows a schematic drawing of a of a locator agent unit Loc and its networking interfaces Contln, Cltnin, and Detln to locator devices or detectors Det, locator client devices Cltn, and to control devices Contr.

The locator devices Det interact with the locator agent unit Loc via a detector interface Detln. The locator devices Det provide measurements and detections MD about where a focused object, e.g. the user is, e.g. via position measurements. Such measurements might be a GPS originated coordinate as well as a audio device recognizing the user's voice enabling concluding that the user might be in the near of the location of said audio device. Generally a system of detectors could provide via the detector interface Detln in a synchronous or asynchronous way measurements and detections MD. The locator might subscribe or retrieve such information in order to update the location model Loc. The detector environment might be very heterogeneous, e.g. comprising a mobile network tracking the position of mobiles, a GPS device carried by the user allowing to identify the user's GPS coordinates, a local network system comprising sensitive devices and active batches etc. The locator agent unit needs to be aware about the locator devices and the reliability of the provided measurements and detections. The locator agent units might be enabled to choose alternative detectors or even to seek/investigate new locator devices or sources in an intelligent way, accomplishing the awareness about locator devices.

The control devices Contr communicating via the control interface Contln with the locator agent unit Loc. Control devices Contr might be computer terminals with browsers or mobiles. Such devices when authorized or when trusted are enabled to define the locator agent unit's behavior via e.g. preference settings. The exchanged information comprises instructions and preferences Pl defining the behavior and the personalization of a locator agent unit Loc.

The client devices Clnt communicating via a the client interface Clntln with the locator agent unit Loc. Client devices Cltn might be a locator device Det, too, as well as services or other locator agent units. A real client device might be mobiles, palm tops, or wearables etc. The client devices Clnt and the locator agent unit exchange requests and replies comprising of location information. A client devices Clnt or its user might be required to authenticate itself to authorize an inquiry in order to keep privacy. The client devices Clnt might even exchange contracts about location information exchange.

To prevent third parties from accessing location information it is preferred to communicate via the networking interfaces Detln, Clntln, and Contln in a secure way using authorization techniques like authentication procedures and encryption procedures for information exchange and transactions like public key encryption, e.g. the well known asymmetric cryptography procedure by Ron Rivest, Adi Shamir, and Leonard Adleman (RSA), electronic signatures and certificates or Secure Socket Layer (SSL), based also on symmetric cryptography. The application of cryptography procedures inhibit that third parties are able to spy location information or location information (based) transactions, or tasks.

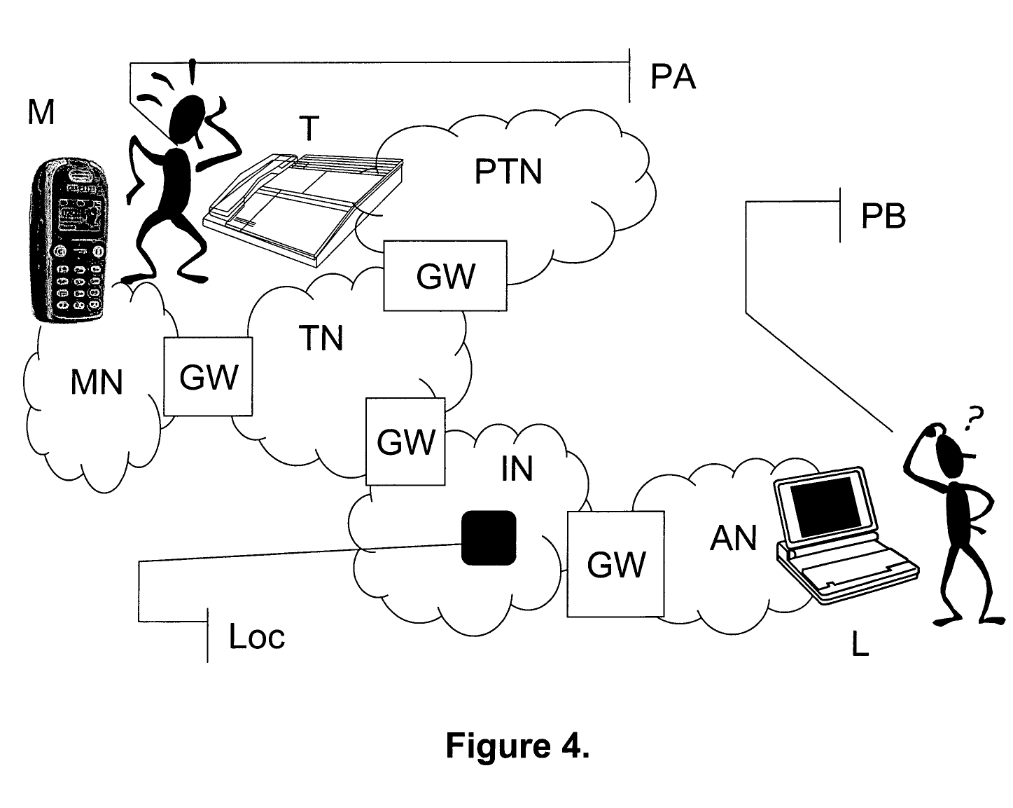

FIG. 4 shows a schematic drawing of a scenario illustrating the functionality of a distributed locator system according to the invention. The scenario shows that a first person PA is seek by a second person PB. The schematic drawing comprises of several networks, an access network AN, an Internet IN, a mobile network MN, a telecommunication network TN, and a plain telecommunication network PTN. The networks are interconnected via gateways GW. The Internet In comprises a locator agent unit Loc personalized for the first person PA. This locator agent unit Loc has subscribed several locator devices, namely in the scenario shown a mobile M and a telephone T. The locator agent unit uses the networking infrastructure to access and gather location information from these locator devices. The mobile M is furthermore a control device for said locator agent unit enabling the first person PA to control the locator agent unit Loc, e.g. by setting preferences.

The second person PB is assumed using a laptop L as client device for inquiring location information of the first person PA. The client device establishes a connection between a for the first person PA personalized location agent unit Loc via the access network AN. The locator agent unit's client interface might be realized as a web service. When a connection is established the second person PB (or the laptop) has to authenticate itself allowing the locator agent unit Loc to conclude about the inquires identity and privileges or granted location information. When the inquirer is authenticated and authorized for processing the inquiry transaction the locator agent unit provides the (aggregated) location information of the first person PA to the laptop L.

A (second) pro-active agent scenario might be that the location agent unit Loc becomes aware of the opportunity of a co-location of the two persons PA and PB by gathering as described above location measurements and detections from said locator devices M and T for the first person PA. The location of the second person might be derived by recognizing directly the laptop activity at a certain access point, e.g. an used network address or by the second person's locator agent unit. The activity in this scenario might be a SMS on the first persons mobile and an e-mail to the second person's laptop reminding both to meet together because of their proximity.

The scenarios illustrate how the locator agent unit interact with the environments, i.e. the networks and the users and how it could provide valuable services.

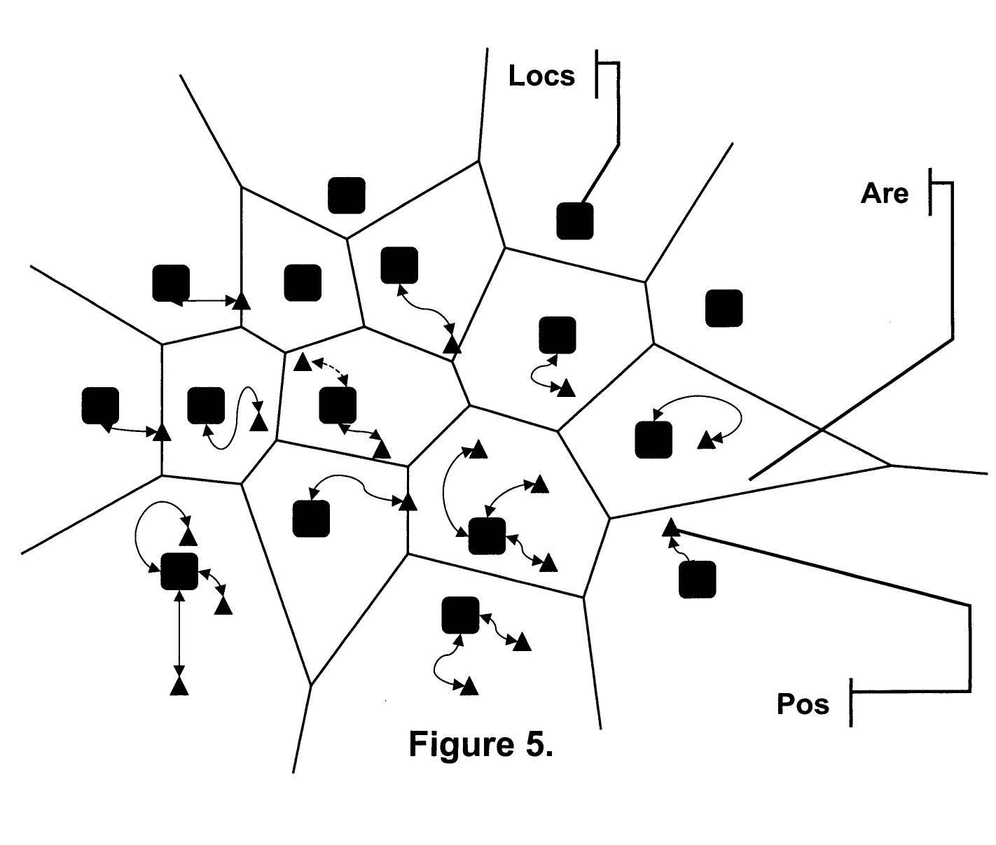

FIG. 5 shows a schematic drawing of distributed locator agent units Locs within a distributed locator system according to the invention. The system comprises locator agent units Locs responsible for certain areas Are. Where an area is a part of the space where objects or persons are located. A locator agent unit might simulate multiple personalized locator agent units.

Influenced from the idea of Vornoi diagrams and cellular networks a spatial load balancing reducing communication effort it is preferred to co-locate the personalized locator agent units having similar location information, i.e. where the persons are close together the personalized locator agent units are together, too. In the figure the located objects, e.g. persons, are indicated by black triangles. Each cell having a locator agent unit comprising personalized locator agent units where the persons are located in the same cell.

The distributed location system provide an efficient platform for handling location information in an efficient, private, and secure way. The system provides a uniform access to location information and mediates via its networking interfaces between the heterogeneous world of the locator devices and locator service consumers, technically represented as clients.

What is claimed is:

1. A Method for coordinating location dependent information, services, or tasks, comprising the steps of
deriving and refining location information of at least one user based on location measurements or proximity observations,
providing location information of said at least one user,
initiating tasks, providing information, or services dependent on said location information,
by a locator entity in a distributed system gathering said location measurements or proximity observations and aggregating said location information of said of at least one user, said locator entity restricting the accesses to said location information by further comprising the steps of
authenticating and authorizing or trusting inquirer parties, and
serving location information requests according to inquirer's grants
wherein said grants depend on the relative location or absolute location of an inquirer or a user, an inquirer's identity, an inquirer's intention, a user's intention, time, or an information exchange contract.

2. The Method according to claim 1, wherein said location information is encrypted (for ensuring privacy).

3. The Method according to claim 1, wherein for said authenticating and authorizing or trusting cryptography techniques are applied.

4. The Method according to claim 1, wherein the method comprises the further step of investigating said distributed system for identifying and coordinating location information sources or inquirers' and other parties' clients.

5. The Method according to claim 1, wherein said provided location information further comprises tracking information or planned location information.

6. The Method according to claim 1, wherein said location information is a fusion of multiple location measurements or multiple proximity observations improving the location precision and reliability.

7. The Method according to claim 1, further comprising the step of pro active involving a user or another party dependent on location, time, or contextual user preferences.

8. The Method according to claim 1, further comprising the step of specifying the behavior of the locator entity or inquirer's grants by an authenticated and authorized party.

9. A Locator Agent Unit for coordinating location dependent information, services, or tasks
comprising locating means for receiving and/or deriving location information and providing location information and
comprising means for initiating tasks or services dependent on the derived location information
comprising a uniform networking interface for detecting devices feeding location information, enabling communication with inquirers' and other parties' client, and allowing controlling the locator agent unit, wherein said locator agent unit comprises
investigation means for identifying and coordinating location information sources or inquirers' and other parties' clients.

10. The Locator Agent Unit according to claim 9, comprising a map unit for collecting location information from said sources, aggregating said location information onto a virtual map (LocMod), and organization means for coordinating location dependent information, services, or tasks dependent on said aggregated location and depend on the relative location or absolute location of a inquirer or a user, an inquirer's identity, an inquirer's intention, a user's intention, time, or an information exchange contract.

11. The Locator Agent Unit according to claim 9, further comprising means for authenticating and authorizing client devices or inquirers.

12. The Locator Agent Unit according to claim 9, wherein said locator agent unit further comprises means for location information encryption and decryption for ensuring privacy.

13. The Locator Agent Unit according to claim 9, wherein said locator agent unit is realized by a network service.

14. The Locator Agent Unit according to claim 12, wherein said network service is realized by an Internet service.

15. A Locator Device for coordinating location dependent information, services, and tasks, providing location measurements and proximity observations of a user, wherein said locator device provides a network interface to a locator agent unit's investigation means for identifying and coordinating location information sources or inquirers' and other parties' clients.

16. A Locator Client Device for exchanging location dependent information or coordinating location dependent services or tasks by comprising communication means for communicating requests and location dependent information wherein said locator client device comprises a network interface to a locator agent units's investigation means for identifying and coordinating location information sources or inquirers' and other parties' clients.

17. A Distributed Locator System for providing coordinated location information dependent information, services, or tasks, comprising a network and locator agent units providing a uniform location information interface, wherein a personalized locator agent unit is located in the distributed locator system dependent on said location information.

18. A Computer Software Product for coordinating location dependent information, services, and tasks comprising computer program means for performing the method according to claim 1.
